(19) United States
(12) Patent Application Publication
(10) Pub. No.: US 2014/0269466 A1
(43) Pub. Date: Sep. 18, 2014

(54) CONTROLLING WI-FI SERVICE IN A VEHICLE

(71) Applicant: GENERAL MOTORS LLC, Detroit, MI (US)

(72) Inventors: Kevin W. Owens, Sterling Heights, MI (US); Daniel C. McGarry, Oxford, MI (US); Eric T. Hosey, Rochester, MI (US); Joshua M. Sine, Beverly Hills, MI (US)

(21) Appl. No.: 13/826,153

(22) Filed: Mar. 14, 2013

(51) Int. Cl. H04W 24/04; H04W 52/02

(52) U.S. Cl. CPC H04W 24/04; H04W 52/0261
USPC 370/311

(57) ABSTRACT

A method of controlling a Wi-Fi service provided by a vehicle includes detecting at the vehicle that an ignition switch of the vehicle is turned off; wirelessly receiving at the vehicle a message that controls the operation of the Wi-Fi service while the ignition switch of the vehicle is turned off; and activating or deactivating the Wi-Fi service provided by the vehicle in response to the wirelessly-received message while the ignition switch of the vehicle is turned off.

### TECHNICAL FIELD

The present invention relates to wireless communications and more particularly to wirelessly controlling Wi-Fi service in a vehicle.

### BACKGROUND

Modern vehicles often include vehicle telematics units that can provide services, such as communications and vehicle monitoring. The variety of services offered by vehicles is increasing. For example, vehicles can offer Internet access to nearby wireless device users via a wireless local area network (WLAN). This can be generically referred to as a Wi-Fi “hotspot” that is provided by the vehicle. While vehicle telematics units can act as a router to provide a Wi-Fi hotspot, the user of the vehicle carrying the vehicle telematics unit may want to control operation of the vehicular Wi-Fi hotspot offered by his or her vehicle.

### SUMMARY

According to an embodiment of the invention, there is provided a method of controlling a Wi-Fi service provided by a vehicle. The method includes detecting at the vehicle that an ignition switch of the vehicle is turned off; wirelessly receiving at the vehicle a message that controls the operation of the Wi-Fi service while the ignition switch of the vehicle is turned off; and activating or deactivating the Wi-Fi service provided by the vehicle in response to the wirelessly-received message while the ignition switch of the vehicle is turned off.

According to another embodiment of the invention, there is provided a method of controlling a Wi-Fi service provided by a vehicle. The method includes generating a wireless message that controls Wi-Fi service provided by the vehicle using a software application stored on a mobile device; wirelessly transmitting the wireless message from the mobile device to the vehicle; and changing an operating mode of the Wi-Fi service at the vehicle based on the wireless message while an ignition switch of the vehicle is turned off.

According to yet another embodiment of the invention, there is provided a method of controlling a Wi-Fi service provided by a vehicle. The method includes generating a wireless message that controls Wi-Fi service using a mobile device; wirelessly transmitting the wireless message to the vehicle; changing an operating mode of the Wi-Fi service at the vehicle based on the wireless message while an ignition switch of the vehicle is turned off; monitoring a battery condition of the vehicle providing the Wi-Fi service while the Wi-Fi service is provided using a vehicle telematics unit; and wirelessly transmitting a battery condition message to the mobile device while the Wi-Fi service is active and the battery condition of the vehicle has fallen below or rises above a predetermined threshold.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of using the method disclosed herein; and

FIG. 2 is a flow chart depicting an embodiment of a method of controlling Wi-Fi service in a vehicle.

### DETAILED DESCRIPTION OF THE ILLUSTRATED EMBODIMENTS

The method described below controls Wi-Fi service provided by a vehicle (e.g., a Wi-Fi “hotspot”) while the ignition switch of the vehicle is turned off. Generally speaking, when the ignition switch of the vehicle is off, users of the vehicle may have little control over vehicle function. For instance, when the ignition switch is off many in-vehicle functions offered by the vehicle are now inaccessible. Similarly, switching the ignition switch off also can make the vehicle functions inaccessible to remotely-located third parties, such as vehicle telematics services that communicate with the vehicle via a vehicle telematics unit.

One of these vehicle functions is a Wi-Fi service provided by the vehicle. Wi-Fi service generally refers to a wireless access point or a wireless local area network (WLAN). While the wireless access point or WLAN will be described as “Wi-Fi,” “Wi-Fi service,” or a Wi-Fi “hotspot,” these terms also include any one of the IEEE 802.11 standards used for short-range communications. The vehicle can provide the Wi-Fi service using equipment and software that wirelessly communicates data between one or more clients (e.g., mobile devices) and the wireless carrier system. In one example, this equipment can be implemented using a vehicle telematics unit. Through such hardware as the vehicle telematics unit, the vehicle can provide Wi-Fi service to a local area surrounding the vehicle.

However, the vehicle users may wish to control vehicle functions even though the vehicle ignition is switched off. One of these vehicle functions is Wi-Fi service provided by the vehicle. And controlling how the Wi-Fi service is provided can be helpful. In one example, a vehicle user, such as a vehicle occupant or owner, has left the vehicle and entered a nearby building. After leaving the vehicle, the vehicle user may want to access the Internet using a mobile phone. The mobile phone can detect Wi-Fi service provided by sources other than the vehicle. But, these sources may not be trusted by the vehicle user or the Wi-Fi service may be password-protected. In these cases it can be helpful to activate the Wi-Fi service provided by the vehicle even though the vehicle ignition is turned off.

When the vehicle user wants to activate or deactivate the Wi-Fi service provided by the vehicle, he or she can do so using the mobile phone. The vehicle user can select a function (e.g., activating or deactivating the Wi-Fi service) and generate a wireless message that instructs the vehicle to carry out that function using the mobile phone. The vehicle generally may not receive commands while the vehicle ignition is off. However, the vehicle can be placed in a state to receive particular wireless messages, such as the wireless message instructing the vehicle to activate or deactivate the Wi-Fi service while the vehicle ignition is off. In this way, the vehicle user can be located away from the vehicle but close enough that short-range wireless communication with the vehicle is possible. For example, the vehicle can be placed in a discontinuous receive (DRx) mode that is much like a “sleep” mode for conserving power. But even while the vehicle is in the DRx mode, the vehicle can be instructed to receive or listen for certain messages, such as the wireless message activating/deactivating the Wi-Fi service. When this happens, the vehicle user can use the Wi-Fi service provided by the vehicle even though the ignition is off by sending a wireless message to the vehicle. After activating the Wi-Fi service of the vehicle, the user can use the Wi-Fi service when in range of the vehicle.

In addition, the vehicle can alert the vehicle user regarding the battery status of the vehicle while the Wi-Fi is active and the vehicle ignition is off. The vehicle telematics unit can send a message to the mobile device belonging to the vehicle user when the battery condition or charge state of the vehicle battery falls below a particular level. It is also possible to send a message to the mobile device informing the vehicle user of an amount of time remaining before the Wi-Fi service provided by the vehicle will end. The Wi-Fi service can be controlled so that it can offer the vehicle user a secured network when others are not available.

### Communications System—

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple, Inc. and the Android™ manufactured by Motorola, Inc. as well as others. While the smart phone 57 may include the ability to communicate via cellular communications using the wireless carrier system 14, this is not always the case. For instance, Apple manufactures devices such as the iPad™, iPad 2™, and the iPod Touch™ that include the processing capability, the display 59, and the ability to communicate over a short-range wireless communication link. However, the iPod Touch and some iPads do not have cellular communication capabilities. Even so, these and other similar devices may be used or considered a type of mobile device, such as the smart phone 57, for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

Turning now to FIG. 2, there is shown a method 200 of controlling a Wi-Fi service provided by the vehicle 12. The method 200 begins at step 210 by generating a wireless message that controls Wi-Fi service using a mobile device, such as the smart phone 57. While other types of mobile devices are possible, the method 200 will be described below with respect to the smart phone 57. The vehicle user can select a messaging software application and use the application to choose the vehicle 12 that has a desired Wi-Fi service as well as an action associated with the desired Wi-Fi service. For example, the vehicle user can select one of a plurality of vehicles the user owns or uses and then select whether to activate or deactivate Wi-Fi service. It should also be appreciated that vehicle users may only own or use one vehicle and in that case the vehicle user may launch the messaging software application and select whether to activate or deactivate the Wi-Fi service.

In one implementation, the messaging software application can be an SMS messaging application. In another implementation, the messaging software can be directed primarily to controlling vehicle functions, such as Wi-Fi service. With respect to the latter example, the messaging software can generate graphical icons on the display 59 of the smart phone 57 that each represent a vehicle function. By selecting the graphical icon(s), the vehicle user can thereby generate a message that effectuates the desired vehicle function. The messaging software application can be included with the smart phone 57 from the manufacturer of smart phone or the application can be obtained wirelessly from an application provider, such as the “App Store” or “Google Play” owned/operated by Apple and Google, respectively. One example of such a messaging software application is the Remote Link application offered by OnStar. The messaging software application can be stored in non-volatile memory carried by the smart phone 57. The method 200 proceeds to step 220.

At step 220, the wireless message that controls Wi-Fi service is wirelessly transmitted to the vehicle 12. Once generated, the wireless message can be wirelessly transmitted from the smart phone 57 to the vehicle 12 and can arrive at the vehicle 12 from the smart phone 57 via a variety of communication paths. For example, the wireless message can be sent from the smart phone 57 to the vehicle 12 (e.g., vehicle telematics unit 30) through the cell tower 70 and wireless carrier system 14. It is also possible to send the wireless message directly from the smart phone 57 to the vehicle telematics unit 30, such as can be accomplished in a peer-to-peer communication arrangement. The method 200 proceeds to step 230.

At step 230, an operating mode of the Wi-Fi service provided at the vehicle is changed based on the wireless message while an ignition switch of the vehicle is turned off. As discussed above, the vehicle 12 may have limited functionality when the vehicle ignition is turned off. When the ignition is “off” the vehicle telematics unit 30 can receive a limited variety of messages, such as when the unit 30 has been placed in the DRx mode. As part of the DRx mode, the vehicle telematics unit 30 can be directed to receive the wireless message generated and sent as described above. When the vehicle telematics unit 30 receives the wireless message, the unit 30 can identify the action to be carried out and/or the operating mode of the vehicle function (e.g., Wi-Fi service) to be controlled based on the message. For instance, the wireless message can include a command or a computer-readable instruction that when executed activates the Wi-Fi service provided by the vehicle 12. Similarly, a separate wireless message can be sent later and include a command/computer-readable instruction that deactivates the Wi-Fi service. The method 200 proceeds to step 240.

At step 240, the battery condition of the vehicle 12 is monitored while the Wi-Fi service is provided. Given that the ignition of the vehicle 12 is switched off, the vehicle 12 may lack the ability to both provide Wi-Fi service and maintain the battery of the vehicle 12 at an acceptable level of charge. That is, the vehicle 12 may not be able to replenish the battery power consumed by the Wi-Fi service when the vehicle ignition is off. As a result, the vehicle 12 can monitor the battery condition of the vehicle 12 while Wi-Fi is provided. The condition of the battery can include a number of variables, such as voltage, rate of discharge, and temperature to name a few. The vehicle telematics unit 30 can begin monitoring the battery condition of the vehicle 12 while the Wi-Fi service is activated and the ignition is off. When values associated with the battery condition rise above or fall below predetermined thresholds, the vehicle telematics unit 30 can generate a battery condition message. The method 200 proceeds to step 250.

At step 250, a battery condition message is wirelessly transmitted to the smart phone 57. When Wi-Fi service is active and the battery condition of the vehicle has fallen below a predetermined threshold, the vehicle telematics unit 30 can generate the battery condition message and wirelessly transmit that message to the smart phone 57. In order to prevent the battery of the vehicle 12 from falling below optimum levels, the vehicle 12 can alert the vehicle user about the condition of the battery as well as future changes in the Wi-Fi service provided by the vehicle 12. For example, the vehicle telematics unit 30 can detect that the vehicle ignition is off, the vehicle 12 is providing Wi-Fi service, and that the vehicle battery is below 70% charge. When these conditions occur, the vehicle telematics unit 30 can generate a message that informs the vehicle user that vehicle battery levels are low and suggests the user turn off the Wi-Fi service. In another example, the vehicle telematics unit 30 can determine that the battery condition is above or below predetermined thresholds and as a result set a timer to control Wi-Fi service provided at the vehicle 12. That is, the vehicle telematics unit 30 can set the timer for 15 minutes and then generate/send a battery condition message to the smart phone 57 informing the vehicle user that the Wi-Fi service will end in 15 minutes. The vehicle 12 through the vehicle telematics unit 30 can receive a wireless message that instructs the unit 30 to stop providing Wi-Fi service or the unit 30 can end Wi-Fi service after the 15 minutes have expired without receiving vehicle user input.

Other messages and actions are possible. For instance, the battery condition message can also encourage the vehicle user to remotely start the vehicle 12 in order to re-charge the vehicle battery. Using the messaging software application described above, the vehicle user can remotely control vehicle functions (e.g., locking/unlocking doors, honking the horn, or starting the vehicle 12). In response to the battery condition message informing the vehicle user that the vehicle battery charge is low, the vehicle user can remotely start the vehicle 12 in response to this message. By starting the vehicle 12, the vehicle user can extend the amount of time the vehicle provides Wi-Fi service. And if the vehicle telematics unit 30 had initiated a timer for providing Wi-Fi service, the act of remotely starting the vehicle 12 can serve to reset the timer. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling a Wi-Fi service provided by a vehicle, comprising the steps of:
(a) detecting at the vehicle that an ignition switch of the vehicle is turned off;
(b) wirelessly receiving at the vehicle a message that controls the operation of the Wi-Fi service while the ignition switch of the vehicle is turned off; and
(c) activating or deactivating the Wi-Fi service provided by the vehicle in response to the wirelessly-received message while the ignition switch of the vehicle is turned off.

2. The method of claim 1, further comprising the step of monitoring a battery condition of a vehicle battery while the Wi-Fi service is activated.

3. The method of claim 2, further comprising the step of sending a battery condition message to a mobile device when the battery condition rises above or falls below a predetermined value.

4. The method of claim 2, further comprising the step of limiting the amount of time the Wi-Fi service is activated based on the monitored battery condition of the vehicle battery.

5. The method of claim 3, wherein the battery condition message instructs a vehicle user to remotely start the vehicle.

6. The method of claim 1, further comprising the step of generating the message that controls the operation of the Wi-Fi service using a messaging software application stored at a mobile device.

7. The method of claim 6, wherein the messaging software application controls one or more vehicle functions in addition to the Wi-Fi service provided by the vehicle.

8. The method of claim 6, wherein the messaging software application displays a vehicle identifier and a vehicle function associated with the vehicle identifier using a display of the mobile device.

9. A method of controlling a Wi-Fi service provided by a vehicle, comprising the steps of:
(a) generating a wireless message that controls Wi-Fi service provided by the vehicle using a software application stored on a mobile device;
(b) wirelessly transmitting the wireless message from the mobile device to the vehicle; and
(c) changing an operating mode of the Wi-Fi service at the vehicle based on the wireless message while an ignition switch of the vehicle is turned off.

10. The method of claim 9, further comprising the step of receiving a battery condition message at the mobile device when a battery condition of a vehicle battery rises above or falls below a predetermined value.

11. The method of claim 10, wherein the battery condition message instructs a vehicle user to remotely start the vehicle.

12. The method of claim 9, wherein the software application stored on the mobile device further comprises a messaging software application.

13. The method of claim 12, wherein the messaging software application controls one or more vehicle functions in addition to the Wi-Fi service provided by the vehicle.

14. The method of claim 12, wherein the messaging software application displays a vehicle identifier and a vehicle function associated with the vehicle identifier using a display of the mobile device.

15. A method of controlling a Wi-Fi service provided by a vehicle, comprising the steps of:
(a) generating a wireless message that controls Wi-Fi service using a mobile device;
(b) wirelessly transmitting the wireless message to the vehicle;
(c) changing an operating mode of the Wi-Fi service at the vehicle based on the wireless message while an ignition switch of the vehicle is turned off;
(d) monitoring a battery condition of the vehicle providing the Wi-Fi service while the Wi-Fi service is provided using a vehicle telematics unit; and
(e) wirelessly transmitting a battery condition message to the mobile device while the Wi-Fi service is active and the battery condition of the vehicle has fallen below or rises above a predetermined threshold.

16. The method of claim 15, further comprising the step of limiting the amount of time the Wi-Fi service provided by the vehicle is activated based on the monitored battery condition of the vehicle.

17. The method of claim 15, wherein the battery condition message instructs a vehicle user to remotely start the vehicle.

18. The method of claim 15, further comprising the step of generating the wireless message that controls Wi-Fi service using a messaging software application stored at the mobile device.

19. The method of claim 18, wherein the messaging software application controls one or more vehicle functions in addition to the Wi-Fi service provided by the vehicle.

20. The method of claim 18, wherein the messaging software application displays a vehicle identifier and a vehicle function associated with the vehicle identifier using a display of the mobile device.
